(19) United States
(12) Patent Application Publication
(10) Pub. No.: US 2023/0188757 A1
(43) Pub. Date: Jun. 15, 2023

(54) METHOD AND DEVICE TO FINELY CONTROL AN IMAGE ENCODING AND DECODING PROCESS

(71) Applicant: InterDigital VC Holdings France, SAS, Cesson-Sevigne (FR)

(72) Inventors: Karam Naser, Mouazé (FR); Fabrice LeLeannec, Betton (FR); Tangi Poirier, Thorigné-Fouillard (FR); Philippe De Lagrange, Betton (FR)

(21) Appl. No.: 17/925,426

(22) PCT Filed: May 10, 2021
(86) PCT No.: PCT/EP2021/062270

§ 371 Date: Nov. 15, 2022

(30) Foreign Application Priority Data
May 19, 2020 (EP) 20305523.1
May 22, 2020 (EP) 20305539.7

(51) Int. Cl. H04N 19/70; H04N 19/96

(52) U.S. Cl. CPC H04N 19/70; H04N 19/96

(57) ABSTRACT

A method for decoding comprising obtaining an encoded video stream comprising a bitstream portion gathering high level syntax elements, at least one of said syntax elements providing an information indicating if a use of an encoding tool or feature corresponding to that high level syntax element is allowed in the encoded video stream; and, determining from a high level syntax element comprised in the bitstream portion if a use of an encoding tool or feature is allowed for decoding the encoded video stream, wherein the encoding tool or feature is at least one of Multi-Type Tree, a scaling matrix, Long Term Reference Picture, a maximum transform unit size equal to a predetermined highest possible maximum transform unit size or weighted prediction.

### 1. TECHNICAL FIELD

At least one of the present embodiments generally relates to a method and a device for image encoding and decoding, and more particularly, to a method for constraining a use of at least one encoding tool or feature.

### 2. BACKGROUND ART

To achieve high compression efficiency, video coding schemes usually employ predictions and transforms to leverage spatial and temporal redundancies in a video content. During an encoding, images of the video content are divided into blocks of samples (i.e. Pixels), these blocks being then partitioned into one or more sub-blocks, called original sub-blocks in the following. An intra or inter prediction is then applied to each sub-block to exploit intra or inter image correlations. Whatever the prediction method used (intra or inter), a predictor sub-block is determined for each original sub-block. Then, a sub-block representing a difference between the original sub-block and the predictor sub-block, often denoted as a prediction error sub-block, a prediction residual sub-block or simply a residual block, is transformed, quantized and entropy coded to generate an encoded video stream. To reconstruct the video, the compressed data is decoded by inverse processes corresponding to the transform, quantization and entropic coding.

The complexity of the video compression methods has strongly increased comparing to the first video compression methods such as MPEG-1 (ISO/CEI-11172), MPEG-2 (ISO/CEI 13818-2) or MPEG-4/AVC (ISO/CEI 14496-10). Indeed, many new coding tools appeared, or existing coding tools were refined in the last generations of video compression standards (for example in the international standard entitled Versatile Video Coding (VVC) under development by a joint collaborative team of ITU-T and ISO/IEC experts known as the Joint Video Experts Team (JVET) or in the standard HEVC (ISO/IEC 23008-2—MPEG-H Part 2, High Efficiency Video Coding/ITU-T H.265)).

All possible encoding tools/features do not necessarily need to be activated during an encoding process. An activation/deactivation of some encoding tools can be controlled for example by using high level syntax elements such as constraint flags. The constraint flags are used to define profiles/sub-profiles where certain coding tools/features are deactivated. A majority of encoding tools/features is associated to a constraint flag. However, it can be noticed that for a plurality of tools/features, the constraint flags are missing. These missing constrain flags renders a definition of profiles allowing a fine control of the encoding and decoding process difficult.

It is desirable to propose a solution allowing defining simply profiles/sub-profiles allowing a fine control of the encoding process.

### 3. BRIEF SUMMARY

In a first aspect, one or more of the present embodiments provide a method for decoding comprising: obtaining an encoded video stream comprising a bitstream portion gathering high level syntax elements, at least one of said syntax elements providing an information indicating if a use of an encoding tool or feature corresponding to that high level syntax element is allowed in the encoded video stream; and, determining from a high level syntax element comprised in the bitstream portion if a use of an encoding tool or feature is allowed for decoding the encoded video stream, wherein the encoding tool or feature is at least one of Multi-Type Tree, a scaling matrix, Long Term Reference Picture, a maximum transform unit size equal to a predetermined highest possible maximum transform unit size or weighted prediction.

In a second aspect, one or more of the present embodiments provide a method for encoding comprising: obtaining a video sequence to encode and a set of encoding constraints; and, setting a value of a high level syntax element in a bitstream portion gathering high level syntax elements in function of the data representative of the set of encoding constraints, at least one of said syntax elements providing an information indicating if a use of an encoding tool or feature corresponding to that high level syntax element is allowed for encoding the video sequence, wherein the encoding tool or feature is at least one of Multi-Type Tree, a scaling matrix, Long Term Reference Picture, a maximum transform unit size equal to a predetermined highest possible maximum transform unit size or weighted prediction.

In a third aspect, one or more of the present embodiments provide device for decoding comprising: means for obtaining an encoded video stream comprising a bitstream portion gathering high level syntax elements, at least one of said syntax elements providing an information indicating if a use of an encoding tool or feature corresponding to that high level syntax element is allowed in the encoded video stream; and, means for determining from a high level syntax element comprised in the bitstream portion if a use of an encoding tool or feature is allowed for decoding the encoded video stream, wherein the encoding tool or feature being at least one of Multi-Type Tree, a scaling matrix, Long Term Reference Picture, a maximum transform unit size equal to a predetermined highest possible maximum transform unit size or weighted prediction.

In a fourth aspect, one or more of the present embodiments provide a device for encoding comprising: means for obtaining a video sequence to encode and a set of encoding constraints; and, means for setting a value of a high level syntax element in a bitstream portion gathering high level syntax elements in function of the data representative of the set of encoding constraints, at least one of said syntax elements providing an information indicating if a use of an encoding tool or feature corresponding to that high level syntax element is allowed for encoding the video sequence, wherein the encoding tool or feature is at least one of Multi-Type Tree, a scaling matrix, Long Term Reference Picture, a maximum transform unit size equal to a predetermined highest possible maximum transform unit size or weighted prediction.

In a fifth aspect, one or more of the present embodiments provide an apparatus comprising a device according to the third or the fourth aspect.

In a sixth aspect, one or more of the present embodiments provide signal comprising data representative of a bitstream portion gathering high level syntax elements, at least one of said syntax elements providing an information indicating if a use of an encoding tool or feature corresponding to that high level syntax element is allowed in an encoded video stream; wherein, the encoding tool or feature is at least one of Multi-Type Tree, a scaling matrix, Long Term Reference Picture, a maximum transform unit size equal to a predetermined highest possible maximum transform unit size or weighted prediction.

In a seventh aspect, one or more of the present embodiments provide a computer program comprising program code instructions for implementing the method according to the first or the second aspect.

In a eighth aspect, one or more of the present embodiments provide an information storage medium storing program code instructions for implementing the method according to the first or the second aspect.

### 4. BRIEF SUMMARY OF THE DRAWINGS

FIG. 1 illustrates an example of partitioning undergone by an image of pixels of an original video;

FIG. 2 depicts schematically a method for encoding a video stream executed by an encoding module;

FIG. 3 depicts schematically a method for decoding the encoded video stream (i.e. the bitstream);

FIG. 4A illustrates schematically an example of hardware architecture of a processing module able to implement an encoding module or a decoding module in which various aspects and embodiments are implemented;

FIG. 4B illustrates a block diagram of an example of a system in which various aspects and embodiments are implemented;

FIG. 5 depicts schematically a method for signaling activation of some encoding tools/features during an encoding process; and,

FIG. 6 depicts schematically a method for determining activated tools during a decoding process.

### 5. DETAILED DESCRIPTION

In the following description, some embodiments use tools developed in the context of VVC or in the context of HEVC. However, these embodiments are not limited to the video coding/decoding method corresponding to VVC or HEVC and applies to other video coding/decoding methods but also to image coding/decoding methods in which some coding tools/features can be activated/deactivated.

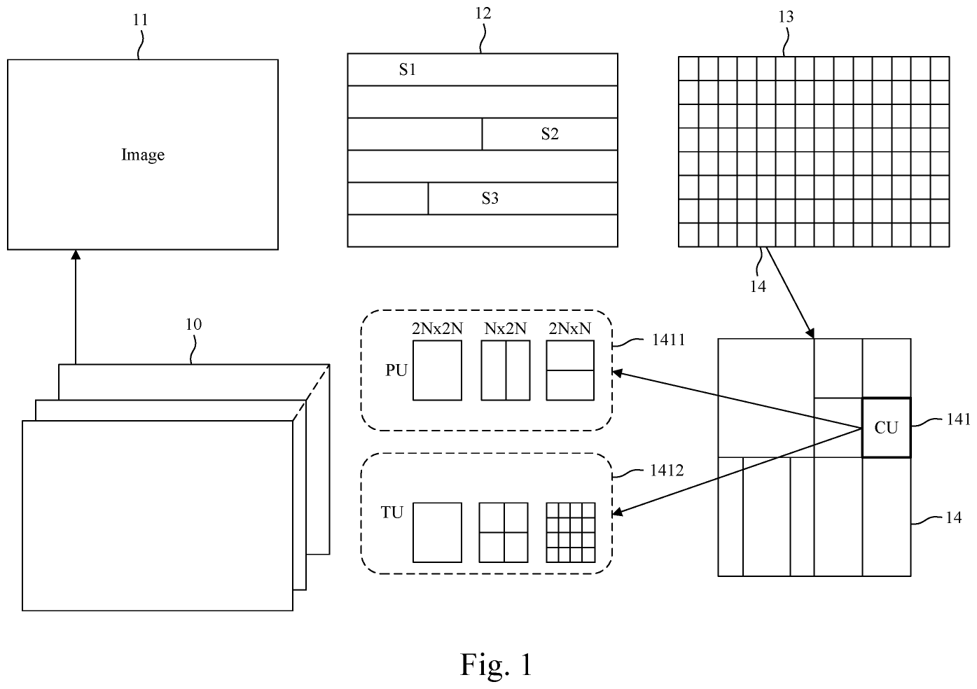

In relation to FIGS. 1, 2 and 3, we describe a video compression method. This method uses many encoding tools/features. As mentioned above, the activation/deactivation of some encoding tools can be controlled by using high level syntax elements such as constraint flags. Constraints flags are gathered in bitstream portion called general_constraint_info. Each constraint flag provides an information indicating if a use of a corresponding tool is allowed in an encoded video stream. For example, the following constraint flags are defined in the bitstream portion general_constraint_info:

TABLE TAB1

| | Descriptor |
|---|---|
| general_constraint_info( ) { | |
| general_non_packed_constraint_flag | u(1) |
| general_frame_only_constraint_flag | u(1) |
| general_non_projected_constraint_flag | u(1) |
| general_one_picture_only_constraint_flag | u(1) |
| intra_only_constraint_flag | u(1) |
| max_bitdepth_constraint_idc | u(4) |
| max_chroma_format_constraint_idc | u(2) |
| single_layer_constraint_flag | u(1) |
| all_layers_independent_constraint_flag | u(1) |
| no_ref_pic_resampling_constraint_flag | u(1) |
| no_res_change_in_clvs_constraint_flag | u(1) |
| one_tile_per_pic_constraint_flag | u(1) |
| pic_header_in_slice_header_constraint_flag | u(1) |
| one_slice_per_pic_constraint_flag | u(1) |
| one_subpic_per_pic_constraint_flag | u(1) |
| no_qtbtt_dual_tree_intra_constraint_flag | u(1) |
| no_partition_constraints_override_constraint_flag | u(1) |
| no_sao_constraint_flag | u(1) |
| no_alf_constraint_flag | u(1) |
| no_ccalf_constraint_flag | u(1) |
| no_joint_cbcr_constraint_flag | u(1) |
| no_mrl_constraint_flag | u(1) |
| no_isp_constraint_flag | u(1) |
| no_mip_constraint_flag | u(1) |
| no_ref_wraparound_constraint_flag | u(1) |
| no_temporal_mvp_constraint_flag | u(1) |
| no_sbtmvp_constraint_flag | u(1) |
| no_amvr_constraint_flag | u(1) |
| no_bdof_constraint_flag | u(1) |
| no_dmvr_constraint_flag | u(1) |
| no_cclm_constraint_flag | u(1) |
| no_mts_constraint_flag | u(1) |
| no_sbt_constraint_flag | u(1) |
| no_lfnst_constraint_flag | u(1) |
| no_affine_motion_constraint_flag | u(1) |
| no_mmvd_constraint_flag | u(1) |
| no_smvd_constraint_flag | u(1) |
| no_prof_constraint_flag | u(1) |
| no_bcw_constraint_flag | u(1) |
| no_ibc_constraint_flag | u(1) |
| no_ciip_constraint_flag | u(1) |
| no_gpm_constraint_flag | u(1) |
| no_ladf_constraint_flag | u(1) |
| no_transform_skip_constraint_flag | u(1) |
| no_bdpcm_constraint_flag | u(1) |
| no_palette_constraint_flag | u(1) |
| no_act_constraint_flag | u(1) |
| no_lmcs_constraint_flag | u(1) |
| no_cu_qp_delta_constraint_flag | u(1) |
| no_chroma_qp_offset_constraint_flag | u(1) |
| no_dep_quant_constraint_flag | u(1) |
| no_sign_data_hiding_constraint_flag | u(1) |
| no_tsrc_constraint_flag | u(1) |
| no_mixed_nalu_types_in_pic_constraint_flag | u(1) |
| no_trail_constraint_flag | u(1) |
| no_stsa_constraint_flag | u(1) |
| no_rasl_constraint_flag | u(1) |
| no_radl_constraint_flag | u(1) |
| no_idr_constraint_flag | u(1) |
| no_cra_constraint_flag | u(1) |
| no_gdr_constraint_flag | u(1) |
| no_aps_constraint_flag | u(1) |
| while( !byte_aligned( ) ) | |
| gci_alignment_zero_bit | f(1) |
| gci_num_reserved_bytes | u(8) |
| for( i = 0; i < gci_num_reserved_bytes; i++ ) | |
| gci_reserved_byte[ i ] | u(8) |
| } | |

For most of the coding tools/features, a constraint flag is defined to disable it. For example, the constraint flag no_alf_constraint_flag specifies that (Adaptive Loop Filtering) ALF is disabled.

It can be noted that for a plurality of tools/features, the constraint flags are missing. The concerned tools/features are:
Multi-type tree (MTT);
Maximum transform unit size;
Scaling lists;
Long term reference picture prediction;
Weighted prediction.

These tools are described in more details in the following.

FIG. 1 illustrates an example of partitioning undergone by an image of samples 11 of an original video 10. It is considered here that a sample is composed of three components: a luminance component and two chrominance components. In that case, a sample corresponds to a pixel. However, the following embodiments are adapted to images constituted of samples comprising another number of components, for instance grey level samples wherein samples comprise one component, or images constituted of samples comprising three color components and a transparency component and/or a depth component.

An image is divided in a plurality of coding entities. First, as represented by reference 13 in FIG. 1, an image is divided in a grid of blocks called coding tree units (CTU). A CTU consists of an N×N block of luminance samples together with two corresponding blocks of chrominance samples. N is in general a power of two having, for example, a maximum value of “128”. Second, an image is divided into one or more groups of CTU. For example, it can be divided into one or more tile rows and tile columns, a tile being a sequence of CTU covering a rectangular region of an image. In some cases, a tile could be divided into one or more bricks, each of which consisting of at least one row of CTU within the tile. Above the concept of tiles and bricks, another encoding entity, called slice, exists, that can contain at least one tile of an image or at least one brick of a tile.

In the example in FIG. 1, as represented by reference 12, the image 11 is divided into three slices S1, S2 and S3, each comprising a plurality of tiles (not represented).

As represented by reference 14 in FIG. 1, a CTU may be partitioned in the form of a hierarchical tree of one or more sub-blocks called coding units (CU). The CTU is the root (i.e. the parent node) of the hierarchical tree and can be partitioned in a plurality of CU (i.e. child nodes). Each CU becomes a leaf of the hierarchical tree if it is not further partitioned in smaller CU or becomes a parent node of smaller CU (i.e. child nodes) if it is further partitioned. Several types of hierarchical trees can be applied comprising for example a quadtree, a binary tree and a ternary tree. In a quadtree, a CTU (respectively a CU) can be partitioned in (i.e. can be the parent node of) “4” square CU of equal sizes. In a binary tree, a CTU (respectively a CU) can be partitioned horizontally or vertically in “2” rectangular CU of equal sizes. In a ternary tree, a CTU (respectively a CU) can be partitioned horizontally or vertically in “3” rectangular CU. For example a CU of height N and width M is vertically (respectively horizontally) partitioned in a first CU of height N (resp. N/4) and width M/4 (resp. M), a second CU of height N (resp. N/2) and width M/2 (resp. M), and a third CU of height N (resp. N/4) and width M/4 (resp. M).

In the example of FIG. 1, the CTU 14 is first partitioned in “4” square CU using a quadtree type partitioning. The upper left CU is a leaf of the hierarchical tree since it is not further partitioned, i.e. it is not a parent node of any other CU. The upper right CU is further partitioned in “4” smaller square CU using again a quadtree type partitioning. The bottom right CU is vertically partitioned in “2” rectangular CU using a binary tree type partitioning. The bottom left CU is vertically partitioned in “3” rectangular CU using a ternary tree type partitioning.

The combination of binary tree and ternary tree is known as Multi-type tree (MTT). MTT is a new encoding tool appeared recently, but no single high-level syntax such as one sequence parameter set (SPS) level flag or a constraint flag is defined. Concerning MTT, three SPS level syntax elements are defined as follows:

TABLE TAB2

| | Descriptor |
|---|---|
| seq_parameter_set_rbsp( ) { | |
| ... | |
| sps_max_mtt_hierarchy_depth_intra_slice_luma | ue(v) |
| ... | |
| sps_max_mtt_hierarchy_depth_inter_slice | ue(v) |
| ... | |
| if( sps_qtbtt_dual_tree_intra_flag ) { | |
| ... | |
| sps_max_mtt_hierarchy_depth_intra_slice_chroma | ue(v) |
| ... | |
| } | |
| ... | |

The semantics of these two SPS level syntax elements is as follows:
sps_max_mtt_hierarchy_depth_intra_slice_luma specifies the default maximum hierarchy depth for coding units resulting from multi-type tree splitting of a quadtree leaf in slices with sh_slice_type equal to “2” (I) referring to the SPS. When sps_partition_constraints_override_enabled_flag is equal to “1”, the default maximum hierarchy depth can be overridden by ph_max_mtt_hierarchy_depth_intra_slice_luma present in PHs referring to the SPS. The value of sps_max_mtt_hierarchy_depth_intra_slice_luma shall be in the range of “0” to 2*(CtbLog2SizeY−MinCbLog2SizeY), inclusive.
sps_max_mtt_hierarchy_depth_inter_slice specifies the default maximum hierarchy depth for coding units resulting from multi-type tree splitting of a quadtree leaf in slices with sh_slice_type equal to “0” (B) or “1” (P) referring to the SPS. When sps_partition_constraints_override_enabled_flag is equal to “1”, the default maximum hierarchy depth can be overridden by ph_max_mtt_hierarchy_depth_inter_slice present in PHs referring to the SPS. The value of sps_max_mtt_hierarchy_depth_inter_slice shall be in the range of “0” to 2*(CtbLog2SizeY−MinCbLog2SizeY), inclusive.
sps_max_mtt_hierarchy_depth_intra_slice_chroma specifies the default maximum hierarchy depth for chroma coding units resulting from multi-type tree splitting of a chroma quadtree leaf with tree Type equal to DUAL_TREE_CHROMA in slices with sh_slice_type equal to “2” (I) referring to the SPS. When sps_partition_constraints_override_enabled_flag is equal to “1”, the default maximum hierarchy depth can be overridden by ph_max_mtt_hierarchy_depth_chroma present in PHs referring to the SPS. The value of sps_max_mtt_hierarchy_depth_intra_slice_chroma shall be in the range of “0” to 2*(CtbLog2SizeY−MinCbLog2SizeY), inclusive. When not present, the value of sps_max_mtt_hierarchy_depth_intra_slice_chroma is inferred to be equal to “0”.

To disable MTT completely, the three SPS level syntax elements sps_max_mtt_hierarchy_depth_intra_slice_luma, sps_max_mtt_hierarchy_depth_inter_slice and sps_max_mtt_hierarchy_depth_intra_slice_chroma shall be zero. A simple way of disabling MTT is desirable.

During the coding of an image, the partitioning is adaptive, each CTU being partitioned in order to optimize a compression efficiency of the CTU criterion.

In some compression method appeared concepts of prediction unit (PU) and transform unit (TU). In that case, the coding entity that is used for prediction (i.e. a PU) and transform (i.e. a TU) can be a subdivision of a CU. For example, as represented in FIG. 1, a CU of size 2N×2N, can be divided in PU 1411 of size N×2N or of size 2N×N. In addition, said CU can be divided in “4” TU 1412 of size N×N or in “16” TU of size (N/2)×(N/2).

In some implementation, a maximum transform unit (TU) size is defined for instance equal to “64” or “32”. For certain profiles, it is important to constrain the maximum transform size to “32” to reduce an overall complexity. concerning the maximum transform unit size, the following SPS level flag is defined sps_max_luma_transform_size_64_flag. Its semantic is:
sps_max_luma_transform_size_64_flag equal to “1” specifies that the maximum transform size in luma samples is equal to “64”. sps_max_luma_transform_size_64_flag equal to “0” specifies that the maximum transform size in luma samples is equal to “32”. When not present, the value of sps_max_luma_transform_size_64_flag is inferred to be equal to “0”.

The flag sps_max_luma_transform_size_64_flag fixes the highest possible maximum TU size to “64”. However, the highest possible maximum TU size could be fixed to other values, for example, to “128” or “256”.

In the present application, the term “block” or “image block” or “sub-block” can be used to refer to any one of a CTU, a CU, a PU and a TU. In addition, the term “block” or “image block” can be used to refer to a macroblock, a partition and a sub-block as specified in MPEG-4/AVC or in other video coding standards, and more generally to refer to an array of samples of numerous sizes.

In the present application, the terms “reconstructed” and “decoded” may be used interchangeably, the terms “pixel” and “sample” may be used interchangeably, the terms “image,” “picture”, “sub-picture”, “slice” and “frame” may be used interchangeably.

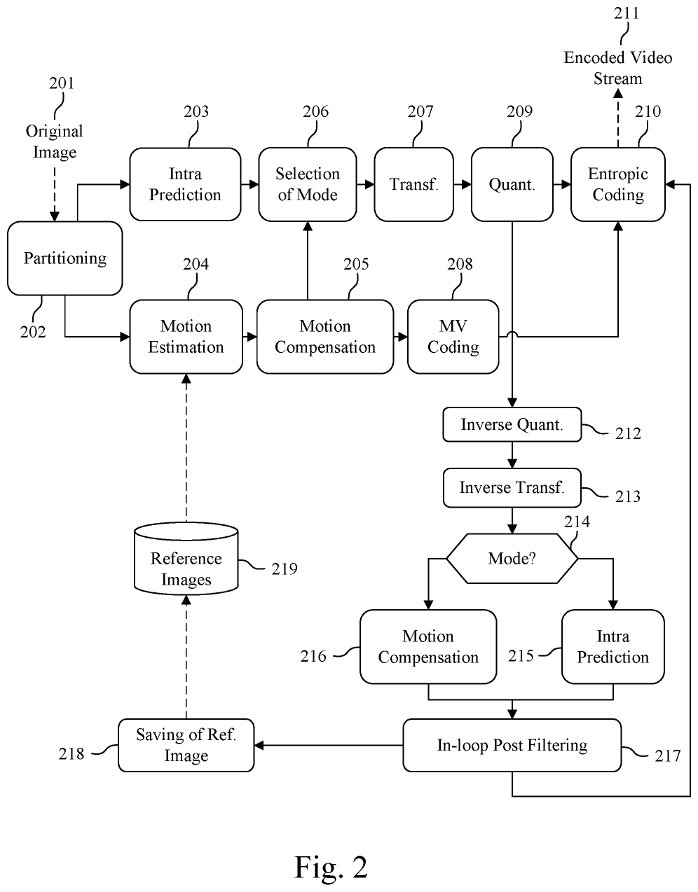

FIG. 2 depicts schematically a method for encoding a video stream executed by an encoding module. Variations of this method for encoding are contemplated, but the method for encoding of FIG. 2 is described below for purposes of clarity without describing all expected variations.

The encoding of a current original image 201 begins with a partitioning of the current original image 201 during a step 202, as described in relation to FIG. 1. The current image 201 is thus partitioned into CTU, CU, PU, TU, etc. For each block, the encoding module determines a coding mode between an intra prediction and an inter prediction.

The intra prediction, represented by step 203, consists of predicting, in accordance with an intra prediction method, the samples of a current block from a prediction block derived from samples of reconstructed blocks situated in a causal vicinity of the current block to be coded. The result of the intra prediction is a prediction direction indicating which samples of the blocks in the vicinity to use, and a residual block resulting from a calculation of a difference between the current block and the prediction block.

The inter prediction consists of predicting the samples of a current block from a block of samples, referred to as the reference block, of an image preceding or following the current image, this image being referred to as the reference image. Two types of reference images have been defined: “short-term reference picture (STRP)” and “long-term reference picture (LTRP)”. Both STRP and LTRP can be used as a reference image for a current block. A corresponding SPS level flag called sps_long_term_ref_pics_flag has been defined with the following semantic:
sps_long_term_ref_pics_flag equal to “0” specifies that no LTRP is used for inter prediction of any coded picture in the CLVS. sps_long_term_ref_pics_flag equal to “1” specifies that LTRPs may be used for inter prediction of one or more coded pictures in the CLVS.

During the coding of a current block in accordance with the inter prediction method, a block of the reference image closest, in accordance with a similarity criterion, to the current block is determined by a motion estimation step 204. During step 204, a motion vector indicating the position of the reference block in the reference image is determined. Said motion vector is used during a motion compensation step 205 during which a residual block is calculated in the form of a difference between the current block and the reference block.

In the first video compression standards, the mono-directional inter prediction mode described above was the only inter mode available. As video compression standards evolved, the family of inter modes has grown significantly and comprises now many different inter modes. One example of tool comprised in the family of inter modes is weighted prediction. Weighted prediction (WP) is a coding tool allowing efficiently encoding video content with fading. WP allows weighting parameters (weight and offset) to be signaled for each reference image in each of the reference image lists L0 and L1. Then, during motion compensation, the weight(s) and offset(s) of the corresponding reference picture(s) are applied. Two SPS level flags are controlling weighted prediction as follows:

TABLE TAB3

| | Descriptor |
|---|---|
| seq_parameter_set_rbsp( ) { | |
| ... | |
| sps_weighted_pred_flag | u(1) |
| sps_weighted_bipred_flag | u(1) |
| ... | |

The semantic of these flags is:
sps_weighted_pred_flag equal to “1” specifies that weighted prediction may be applied to P slices referring to the SPS. sps_weighted_pred_flag equal to “0” specifies that weighted prediction is not applied to P slices referring to the SPS.
sps_weighted_bipred_flag equal to “1” specifies that explicit weighted prediction may be applied to B slices referring to the SPS. sps_weighted_bipred_flag equal to “0” specifies that explicit weighted prediction is not applied to B slices referring to the SPS.

To disable weighted prediction, both flags must be set to zero. A more convenient way of controlling the activation/deactivation of weighted prediction is desirable.

During a selection step 206, the prediction mode optimizing the compression performances, in accordance with a rate/distortion criterion (i.e. RDO criterion), among the prediction modes tested (Intra prediction modes, Inter prediction modes) is selected by the encoding module.

When the prediction mode is selected, the residual block is transformed during a step 207 and quantized during a step 209. During the quantization, in transformed domain, the transformed coefficients are weighted by a scaling matrix in addition to the quantization parameter. The scaling matrix is a coding tool allowing favoring some frequencies at the expense of other frequencies. In general, low frequencies are favored. Some video compression methods allow applying a user-defined scaling matrix (also called scaling list) instead of a default scaling matrix. In that case, parameters of the scaling matrix need to be transmitted to the decoder. It is noted that in many coding scenarios such a feature is not needed. Indeed, in a majority of cases all transform coefficients are treated equally. Concerning the scaling matrix, a SPS level flag sps_explicit_scaling_list_enabled_flag is defined for disabling the scaling matrix. Its semantic is:
sps_explicit_scaling_list_enabled_flag equal to “1” specifies that the use of an explicit scaling list, which is signaled in a scaling list APS, in the scaling process for transform coefficients when decoding a slice is enabled for the CLVS (Coded Layer Video Sequence). sps_explicit_scaling_list_enabled_flag equal to “0” specifies that the use of an explicit scaling list in the scaling process for transform coefficients when decoding a slice is disabled for the CLVS.

Note that the encoding module can skip the transform and apply quantization directly to the non-transformed residual signal.

When the current block is coded according to an intra prediction mode, a prediction direction and the transformed and quantized residual block are encoded by an entropic encoder during a step 210.

When the current block is encoded according to an inter prediction mode, the motion data associated with this inter prediction mode are coded in a step 208.

In general, two modes can be used to encode the motion data, respectively called AMVP (Adaptive Motion Vector Prediction) and Merge.

AMVP basically consists in signaling a reference image(s) used to predict a current block, a motion vector predictor index and a motion vector difference (also called motion vector residual).

The merge mode consists in signaling an index of some motion data collected in a list of motion data predictors. The list is made of “5” or “7” candidates and is constructed the same way on the decoder and encoder sides. Therefore, the merge mode aims at deriving some motion data taken from the merge list. The merge list typically contains motion data associated to some spatially and temporally neighboring blocks, available in their reconstructed state when the current block is being processed.

Once predicted, the motion information is next encoded by the entropic encoder during step 210, along with transformed and quantized residual block. Note that the encoding module can bypass both transform and quantization, i.e., the entropic encoding is applied on the residual without the application of the transform or quantization processes. The result of the entropic encoding is inserted in an encoded video stream (i.e. a bitstream) 211.

Note that the entropic encoder can be implemented in a form of a context adaptive binary arithmetic coder (CABAC). CABAC encodes binary symbols, which keeps the complexity low and allows probability modelling for more frequently used bits of any symbol.

After the quantization step 209, the current block is reconstructed so that the pixels corresponding to that block can be used for future predictions. This reconstruction phase is also referred to as a prediction loop. An inverse quantization is therefore applied to the transformed and quantized residual block during a step 212 and an inverse transformation is applied during a step 213. According to the prediction mode used for the current block obtained during a step 214, the prediction block of the current block is reconstructed. If the current block is encoded according to an inter prediction mode, the encoding module applies, when appropriate, during a step 216, a motion compensation to a reference block using the motion information of the current block. If the current block is encoded according to an intra prediction mode, during a step 215, the prediction direction corresponding to the current block is used for reconstructing the reference block of the current block. The reference block and the reconstructed residual block are added in order to obtain the reconstructed current block.

Following the reconstruction, an in-loop post-filtering intended to reduce the encoding artefacts is applied, during a step 217, to the reconstructed block. This post-filtering is called in-loop post-filtering since this post-filtering occurs in the prediction loop to obtain at the encoder the same reference images as the decoder and thus avoid a drift between the encoding and the decoding processes. For instance, the in-loop post-filtering comprises a deblocking filtering, a SAO (sample adaptive offset) filtering and an Adaptive Loop Filtering (ALF) with block-based filter adaption.

Parameters representative of the activation or the deactivation of the in-loop deblocking filter and when activated, of characteristics of said in-loop deblocking filter are introduced in the encoded video stream 211 during the entropic coding step 210.

When a block is reconstructed, it is inserted during a step 218 into a reconstructed image stored in the decoded picture buffer (DPB) 219. The reconstructed images thus stored can then serve as reference images for other images to be coded.

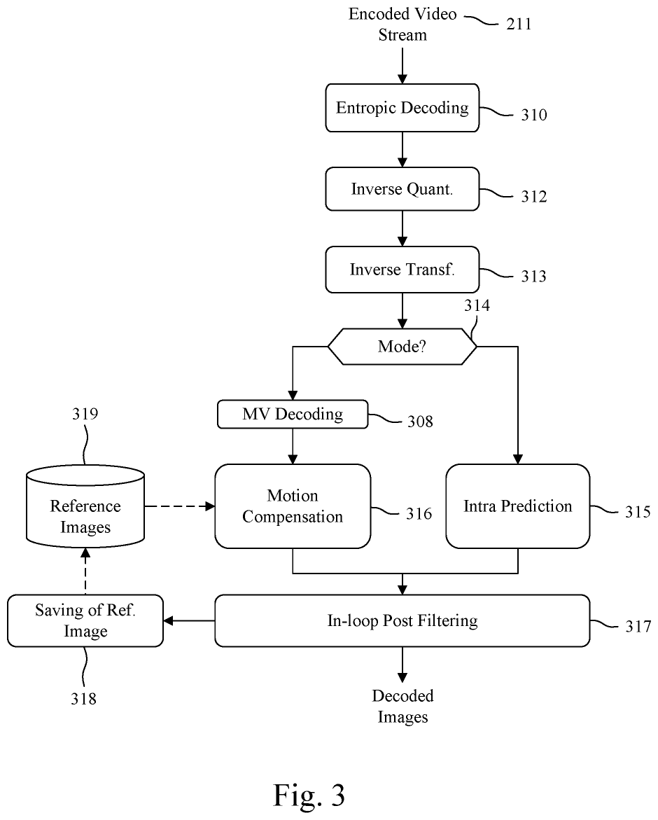

FIG. 3 depicts schematically a method for decoding the encoded video stream (i.e. the bitstream) 211 encoded according to method described in relation to FIG. 2. Said method for decoding is executed by a decoding module. Variations of this method for decoding are contemplated, but the method for decoding of FIG. 3 is described below for purposes of clarity without describing all expected variations.

The decoding is done block by block. For a current block, it starts with an entropic decoding of the current block during a step 310. Entropic decoding allows to obtain the prediction mode of the current block.

If the current block has been encoded according to an intra prediction mode, the entropic decoding allows to obtain, information representative of an intra prediction direction and a residual block.

If the current block has been encoded according to an inter prediction mode, the entropic decoding allows to obtain, information representative of motion data and a residual block. When appropriate, during a step 308, the motion data are reconstructed for the current block according to the AMVP or the merge mode. In the merge mode, the motion data obtained by the entropic decoding comprise an index in a list of motion vector predictor candidates. The decoding module applies the same process than the encoding module to construct the list of candidates for the regular merge mode and a sub-block merge mode. With the reconstructed list and the index, the decoding module is able to retrieve a motion vector used to predict the motion vector of a block.

The method for decoding comprises steps 312, 313, 315, 316 and 317 in all respects identical respectively to steps 212, 213, 215, 216 and 217 of the method for encoding. Whereas at the encoding module level, the step 214 comprises a mode selection process evaluating each mode according to a rate distortion criterion and selecting the best mode, step 314 just consists in reading an information representative of a selected mode in the bitstream 211. Decoded blocks are saved in decoded images and the decoded images are stored in a DPB 319 in a step 318. When the decoding module decodes a given image, the images stored in the DPB 319 are identical to the images stored in the DPB 219 by the encoding module during the encoding of said given image. The decoded image can also be outputted by the decoding module for instance to be displayed.

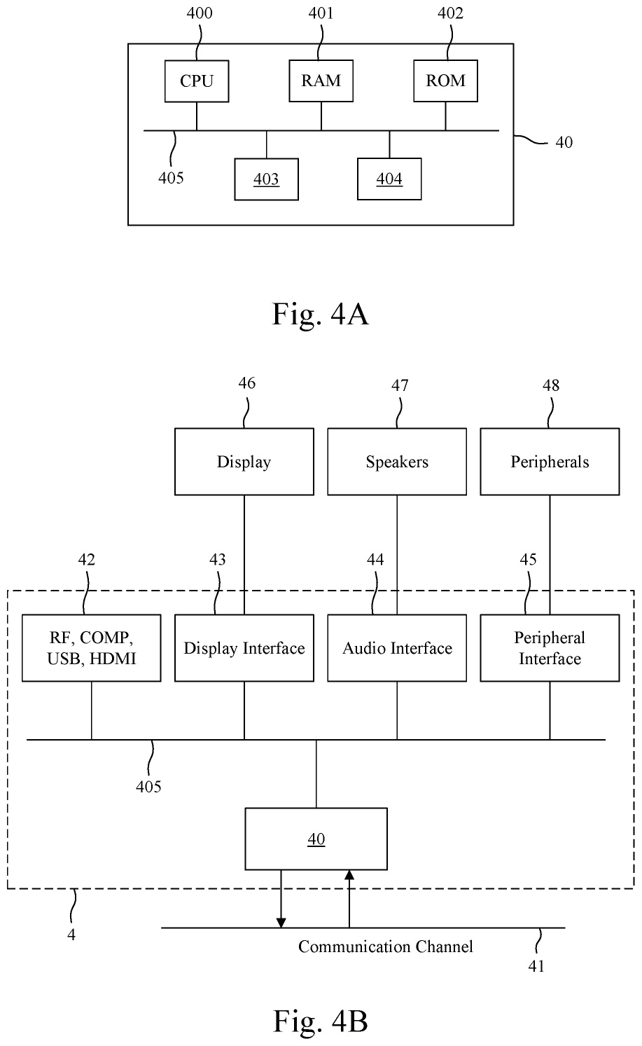

FIG. 4A illustrates schematically an example of hardware architecture of a processing module 40 able to implement an encoding module or a decoding module capable of implementing respectively a method for encoding of FIG. 2 and a method for decoding of FIG. 3 modified according to different aspects and embodiments. The processing module 40 comprises, connected by a communication bus 405: a processor or CPU (central processing unit) 400 encompassing one or more microprocessors, general purpose computers, special purpose computers, and processors based on a multi-core architecture, as non-limiting examples; a random access memory (RAM) 401; a read only memory (ROM) 402; a storage unit 403, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 404 for exchanging data with other modules, devices or equipment. The communication interface 404 can include, but is not limited to, a transceiver configured to transmit and to receive data over communication channel. The communication interface 404 can include, but is not limited to, a modem or network card.

If the processing module 40 implements a decoding module, the communication interface 404 enables for instance the processing module 40 to receive encoded video streams and to provide a decoded video stream. If the processing module 40 implements an encoding module, the communication interface 404 enables for instance the processing module 40 to receive original image data to encode and to provide an encoded video stream.

The processor 400 is capable of executing instructions loaded into the RAM 401 from the ROM 402, from an external memory (not shown), from a storage medium, or from a communication network. When the processing module 40 is powered up, the processor 400 is capable of reading instructions from the RAM 401 and executing them. These instructions form a computer program causing, for example, the implementation by the processor 400 of a decoding method as described in relation with FIG. 3 or an encoding method described in relation to FIG. 2, the decoding and encoding methods comprising various aspects and embodiments described below in this document.

All or some of the algorithms and steps of said encoding or decoding methods may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

FIG. 4B illustrates a block diagram of an example of a system 4 in which various aspects and embodiments are implemented. System 4 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 4, singly or in combination, can be embodied in a single integrated circuit (IC), multiple ICs, and/or discrete components. For example, in at least one embodiment, the system 4 comprises one processing module 40 that implement a decoding module or an encoding module. But, in another embodiment, the system 4 can comprise a first processing module 40 implementing a decoding module and a second processing module 40 implementing an encoding module or one processing module 40 implementing a decoding module and an encoding module. In various embodiments, the system 40 is communicatively coupled to one or more other systems, or other electronic devices, via, for example, a communications bus or through dedicated input and/or output ports. In various embodiments, the system 4 is configured to implement one or more of the aspects described in this document.

The system 4 comprises at least one processing module 40 capable of implementing one of an encoding module or a decoding module or both.

The input to the processing module 40 can be provided through various input modules as indicated in block 42. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 4B, include composite video.

In various embodiments, the input modules of block 42 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 4 to other electronic devices across USB and/or HDMI connections. It is to be understood that various aspects of input processing, for example, Reed-Solomon error correction, can be implemented, for example, within a separate input processing IC or within the processing module 40 as necessary. Similarly, aspects of USB or HDMI interface processing can be implemented within separate interface ICs or within the processing module 40 as necessary. The demodulated, error corrected, and demultiplexed stream is provided to the processing module 40.

Various elements of system 4 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 4, the processing module 40 is interconnected to other elements of said system 4 by the bus 405.

The communication interface 404 of the processing module 40 allows the system 4 to communicate on a communication channel 41. The communication channel 41 can be implemented, for example, within a wired and/or a wireless medium.

Data is streamed, or otherwise provided, to the system 4, in various embodiments, using a wireless network such as a Wi-Fi network, for example IEEE 802.11 (IEEE refers to the Institute of Electrical and Electronics Engineers). The Wi-Fi signal of these embodiments is received over the communications channel 41 and the communications interface 404 which are adapted for Wi-Fi communications. The communications channel 41 of these embodiments is typically connected to an access point or router that provides access to external networks including the Internet for allowing streaming applications and other over-the-top communications. Other embodiments provide streamed data to the system 4 using a set-top box that delivers the data over the HDMI connection of the input block 42. Still other embodiments provide streamed data to the system 4 using the RF connection of the input block 42. As indicated above, various embodiments provide data in a non-streaming manner. Additionally, various embodiments use wireless networks other than Wi-Fi, for example a cellular network or a Bluetooth network.

The system 4 can provide an output signal to various output devices, including a display 46, speakers 47, and other peripheral devices 48. The display 46 of various embodiments includes one or more of, for example, a touchscreen display, an organic light-emitting diode (OLED) display, a curved display, and/or a foldable display. The display 46 can be for a television, a tablet, a laptop, a cell phone (mobile phone), or other devices. The display 46 can also be integrated with other components (for example, as in a smart phone), or separate (for example, an external monitor for a laptop). The other peripheral devices 46 include, in various examples of embodiments, one or more of a stand-alone digital video disc (or digital versatile disc) (DVR, for both terms), a disk player, a stereo system, and/or a lighting system. Various embodiments use one or more peripheral devices 48 that provide a function based on the output of the system 4. For example, a disk player performs the function of playing the output of the system 4.

In various embodiments, control signals are communicated between the system 4 and the display 46, speakers 47, or other peripheral devices 48 using signaling such as AV.Link, Consumer Electronics Control (CEC), or other communications protocols that enable device-to-device control with or without user intervention. The output devices can be communicatively coupled to system 4 via dedicated connections through respective interfaces 43, 44, and 45. Alternatively, the output devices can be connected to system 4 using the communications channel 41 via the communications interface 404. The display 46 and speakers 47 can be integrated in a single unit with the other components of system 4 in an electronic device such as, for example, a television. In various embodiments, the display interface 43 includes a display driver, such as, for example, a timing controller (T Con) chip.

The display 46 and speaker 47 can alternatively be separate from one or more of the other components, for example, if the RF module of input 42 is part of a separate set-top box. In various embodiments in which the display 46 and speakers 47 are external components, the output signal can be provided via dedicated output connections, including, for example, HDMI ports, USB ports, or COMP outputs.

Various implementations involve decoding. “Decoding”, as used in this application, can encompass all or part of the processes performed, for example, on a received encoded video stream in order to produce a final output suitable for display. In various embodiments, such processes include one or more of the processes typically performed by a decoder, for example, entropy decoding, inverse quantization, inverse transformation, and prediction. In various embodiments, such processes also, or alternatively, include processes performed by a decoder of various implementations or embodiments described in this application, for example, for determining if MTT, scaling matrix, long term reference picture, maximum TU size equal to “32” or weighted prediction are activated or not.

Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded video stream. In various embodiments, such processes include one or more of the processes typically performed by an encoder, for example, partitioning, prediction, transformation, quantization, in-loop post-filtering and entropy encoding. In various embodiments, such processes also, or alternatively, include processes performed by an encoder of various implementations or embodiments described in this application, for example, for activating/deactivating MTT, scaling matrix, long term reference picture, maximum TU size equal to “32” or weighted prediction.

Whether the phrase “encoding process” is intended to refer specifically to a subset of operations or generally to the broader encoding process will be clear based on the context of the specific descriptions and is believed to be well understood by those skilled in the art.

Note that the syntax elements names, flags names, containers names, coding tools names as used herein, are descriptive terms. As such, they do not preclude the use of other syntax element, flags, containers, or coding tools names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between a rate and a distortion is usually considered. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of a reconstructed signal after coding and decoding. Faster approaches may also be used, to save encoding complexity, in particular with computation of an approximated distortion based on a prediction or a prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, inferring the information from other information(s), retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, inferring the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, inferring the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals constraints flags indicating whether MTT, scaling matrix, long term reference picture, maximum TU size equal to 32 or weighted prediction are activated or not. In this way, in an embodiment the same parameters are used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the encoded video stream of a described embodiment. Such a signal can be formatted, for example, as an electromagnetic wave (for example, using a radio frequency portion of spectrum) or as a baseband signal. The formatting can include, for example, encoding an encoded video stream and modulating a carrier with the encoded video stream. The information that the signal carries can be, for example, analog or digital information. The signal can be transmitted over a variety of different wired or wireless links, as is known. The signal can be stored on a processor-readable medium.

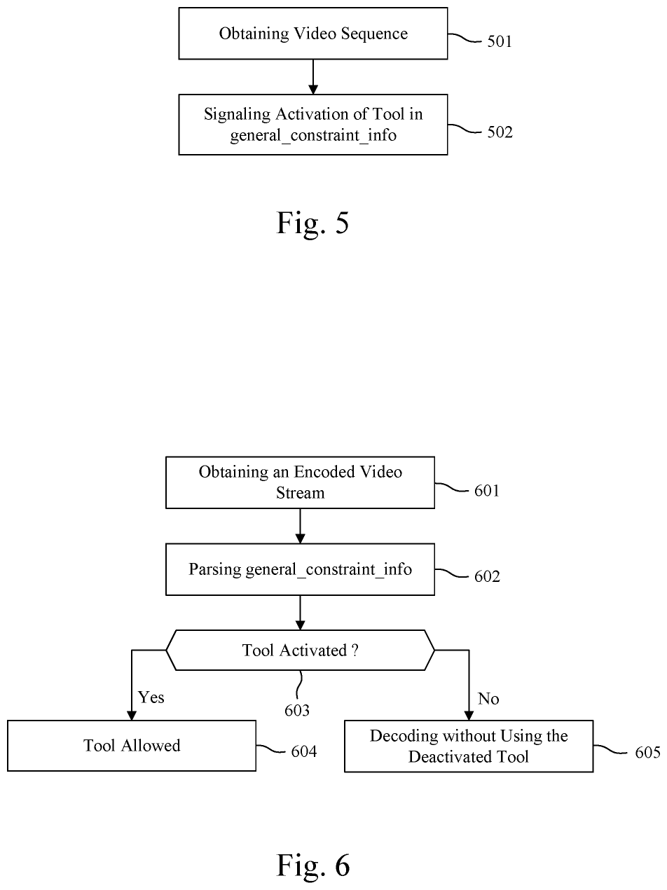

FIG. 5 depicts schematically a method for signaling activation of some encoding tools/features during an encoding process. The method of FIG. 5 is for example executed before encoding a first image of a video sequence using the method depicted in FIG. 2.

In an embodiment, the bitstream portion general_constraint_info is modified as follows to include new constraint flags for activating/deactivating MTT, scaling matrix, long term reference picture, maximum TU size equal to “64” or weighted prediction:

TABLE TAB4

| | Descriptor |
|---|---|
| general_constraint_info( ) { | |
| general_non_packed_constraint_flag | u(1) |
| general_frame_only_constraint_flag | u(1) |
| general_non_projected_constraint_flag | u(1) |
| general_one_picture_only_constraint_flag | u(1) |
| intra_only_constraint_flag | u(1) |
| max_bitdepth_constraint_idc | u(4) |
| max_chroma_format_constraint_idc | u(2) |
| single_layer_constraint_flag | u(1) |
| all_layers_independent_constraint_flag | u(1) |
| no_ref_pic_resampling_constraint_flag | u(1) |
| no_res_change_in_clvs_constraint_flag | u(1) |
| one_tile_per_pic_constraint_flag | u(1) |
| pic_header_in_slice_header_constraint_flag | u(1) |
| one_slice_per_pic_constraint_flag | u(1) |
| one_subpic_per_pic_constraint_flag | u(1) |
| no_qtbtt_dual_tree_intra_constraint_flag | u(1) |
| no_partition_constraints_override_constraint_flag | u(1) |
| no_sao_constraint_flag | u(1) |
| no_alf_constraint_flag | u(1) |
| no_ccalf_constraint_flag | u(1) |
| no_joint_cbcr_constraint_flag | u(1) |
| no_mrl_constraint_flag | u(1) |
| no_isp_constraint_flag | u(1) |
| no_mip_constraint_flag | u(1) |
| no_{—}mtt_{—}constraint_{—}flag | u(1) |
| max_{—}luma_{—}transform_{—}size_{—}32_{—}constraint_{—}flag | u(1) |
| no_{—}scaling_{—}list_{—}constraint_{—}flag | u(1) |
| no_{—}long_{—}term_{—}ref_{—}pic_{—}constraint_{—}flag | u(1) |
| no_{—}weighted_{—}pred_{—}constraint_{—}flag | u(1) |
| no_ref_wraparound_constraint_flag | u(1) |
| no_temporal_mvp_constraint_flag | u(1) |
| no_sbtmvp_constraint_flag | u(1) |
| no_amvr_constraint_flag | u(1) |
| no_bdof_constraint_flag | u(1) |
| no_dmvr_constraint_flag | u(1) |
| no_cclm_constraint_flag | u(1) |
| no_mts_constraint_flag | u(1) |
| no_sbt_constraint_flag | u(1) |
| no_lfnst_constraint_flag | u(1) |
| no_affine_motion_constraint_flag | u(1) |
| no_mmvd_constraint_flag | u(1) |
| no_smvd_constraint_flag | u(1) |
| no_prof_constraint_flag | u(1) |
| no_bcw_constraint_flag | u(1) |
| no_ibc_constraint_flag | u(1) |
| no_ciip_constraint_flag | u(1) |
| no_gpm_constraint_flag | u(1) |
| no_ladf_constraint_flag | u(1) |
| no_transform_skip_constraint_flag | u(1) |
| no_bdpcm_constraint_flag | u(1) |
| no_palette_constraint_flag | u(1) |
| no_act_constraint_flag | u(1) |
| no_lmcs_constraint_flag | u(1) |
| no_cu_qp_delta_constraint_flag | u(1) |
| no_chroma_qp_offset_constraint_flag | u(1) |
| no_dep_quant_constraint_flag | u(1) |
| no_sign_data_hiding_constraint_flag | u(1) |
| no_tsrc_constraint_flag | u(1) |
| no_mixed_nalu_types_in_pic_constraint_flag | u(1) |
| no_trail_constraint_flag | u(1) |
| no_stsa_constraint_flag | u(1) |
| no_rasl_constraint_flag | u(1) |
| no_radl_constraint_flag | u(1) |
| no_idr_constraint_flag | u(1) |
| no_cra_constraint_flag | u(1) |
| no_gdr_constraint_flag | u(1) |
| no_aps_constraint_flag | u(1) |
| while( !byte_aligned( ) ) | |
| gci_alignment_zero_bit | f(1) |
| gci_num_reserved_bytes | u(8) |
| for( i = 0; i < gci_num_reserved_bytes; i++ ) | |
| gci_reserved_byte[ i ] | u(8) |
| } | |

In table TAB4, the added constraint flags are represented in bold.

The semantic of these flags is as follows:
no_mtt_constraint_flag equal to “1” specifies that sps_max_mtt_hierarchy_depth_intra_slice_luma, sps_max_mtt_hierarchy_depth_inter_slice and sps_max_mtt_hierarchy_depth_intra_slice_chroma shall be equal to “0”. no_mtt_constraint_flag equal to “0” does not impose such a constraint. In other words, if no_mtt_constraint_flag equal “1”, MTT is deactivated.
max_luma_transform_size_32_constraint_flag equal to “1” specifies that sps_max_luma_transform_size_64_flag shall be equal to “0”. max_luma_transform_size_32_constraint_flag equal to “0” does not impose such a constraint. In other words, max_luma_transform_size_32_constraint_flag equal “1”, the maximum TU size is “32” and the use of TU of size “64” is not allowed.
no_scaling_list_constraint_flag equal to “1” specifies that sps_explicit_scaling_list_enabled_flag shall be equal to “0”. no_scaling_list_constraint_flag equal to “0” does not impose such a constraint. In other words, the scaling matrix is deactivated when no_scaling_list_constraint_flag is equal to “1”, the use of a non-default scaling matrix is disabled.
no_long_term_ref_pic_constraint_flag equal to “1” specifies that sps_long_term_ref_pics_flag shall be equal to “0”. no_long_term_ref_pic_constraint_flag equal to “0” does not impose such a constraint. In other words, no LTRP is used for inter prediction when no_long_term_ref_pic_constraint_flag is equal to “1”. When intra_only_constraint_flag is equal to “1”, the value of no_long_term_ref_pic_constraint_flag shall be equal to “1”.
no_weighted_pred_constraint_flag equal to “1” specifies that sps_weighted_pred_flag and sps_weighted_bipred_flag shall be equal to “0”. no_weighted_pred_constraint_flag equal to 0 does not impose such a constraint. In other words, no_weighted_pred_constraint_flag equals to “1”, weighted prediction is deactivated. When intra_only_constraint_flag is equal to “1”, the value of no_weighted_pred_constraint_flag shall be equal to “1”.

Back to the method of FIG. 5, in a step 501, the processing module 40 obtains a video sequence to encode. During step 501, the processing module 40 receives also data representative of a profile/sub-profile or of a set of encoding constraints for example fixed by a user.

In a step 502, the processing module 40 sets values of constraints flags in a bitstream portion general_constraint_info. These constraints flags are set in function of the data representative of a profile/sub-profile or of a set of encoding constraints or to default values. For example, the processing module 40 sets the value of the constraint flag no_mtt_constraint_flag (respectively max_luma_transform_size_32_constraint_flag, no_scaling_list_constraint_flag, no_long_term_ref_pic_constraint_flag, no_weighted_pred_constraint_flag) to “1” if MTT is deactivated (respectively the maximum transform unit size is “32”, the use of a scaling matrix is deactivated, the use of LTRP is deactivated, weighted prediction is deactivated). The processing module 40 sets the value of the constraint flag no_mtt_constraint_flag (respectively max_luma_transform_size_32_constraint_flag, no_scaling_list_constraint_flag, no_long_term_ref_pic_constraint_flag, no_weighted_pred_constraint_flag) to “0” if the activation of MTT is allowed at the general_constraint_info level (respectively the use of a maximum transform unit size of “64” is allowed at the general_constraint_info level, the use of a scaling matrix is allowed at the general_constraint_info level, the use of LTRP is allowed at the general_constraint_info level, weighted prediction is allowed at the general_constraint_info level).

FIG. 6 depicts schematically a method for determining activated tools during a decoding process. The method of FIG. 6 is for example executed after receiving an encoded video stream and before decoding a first image of the encoded video stream using the method depicted in FIG. 3. The received encoded video stream comprises a bitstream portion general_constraint_info.

In a step 601, the processing module 40 obtains the encoded video stream comprising the bitstream portion general_constraint_info.

In a step 602, the processing module 40 parses the bitstream portion general_constraint_info.

In a step 603, the processing module 40 determines from constraint flags comprised in the bitstream portion general_constraint_info if the use of MTT, of a scaling matrix, of LTRP, of a maximum transform unit size of “64” or of weighted prediction is allowed. To do so, the processing module 40 determines if the constraint flags no_mtt_constraint_flag, no_scaling_list_constraint_flag, max_luma_transform_size_32_constraint_flag, no_long_term_ref_pic_constraint_flag or no_weighted_pred_constraint_flag are present in the bitstream portion general_constraint_info, and if yes, the value of these flags. If no_mtt_constraint_flag (respectively no_scaling_list_constraint_flag, max_luma_transform_size_32_constraint_flag, no_long_term_ref_pic_constraint_flag, no_weighted_pred_constraint_flag) is equal to “1” , the processing module 40 determines in a step 605 that the use of MTT (respectively of a non-default scaling matrix, of a maximum TU size equal to “64”, of LTRP, of weighted prediction) is not allowed in the encoded video stream. In that case the decoding of the encoded video stream is performed without using the unauthorized tool/feature.

If no_mtt_constraint_flag (respectively no_scaling_list_constraint_flag, max_luma_transform_size_32_constraint_flag, no_long_term_ref_pic_constraint_flag, no_weighted_pred_constraint_flag) is equal to “0” , the processing module 40 determines in a step 604 that the use of MTT (respectively of a scaling matrix, of a maximum TU size equal to “64”, of LTRP, of weighted prediction) is allowed at the bitstream portion general_constraint_info level. In that case the decoding of the encoded video stream can use the allowed tool/feature if this use is not prevented by other means in the encoded video stream.

Additionally, note that in an embodiment, in case the intra_only_constraint_flag of the general constraints flag syntax of the VVC specification is equal to “1”, then the constraint flags no_long_term_ref_pic_constraint_flag, no_weighted_pred_constraint_flag newly introduced are equal to “1” as well.

Indeed, in the VVC specification, the intra_only_constraint_flag equal to “1” specifies that sh_slice_type shall be equal to I (Intra). intra_only_constraint_flag equal to “0” does not impose such a constraint.

Indeed, these two proposed constraint flags relate to the coding of inter block, hence inter picture. Thus, they are not relevant with a VVC coded bitstream where the intra_only_constraint_flag is equal to 1.

Further, embodiments can include one or more of the following features, devices, or aspects, alone or in any combination, across various claim categories and types:
A bitstream or signal that includes syntax conveying information generated according to any of the embodiments described;
Inserting in the signaling syntax elements that enable the decoder to adapt the decoding process in a manner corresponding to that used by an encoder;
Creating and/or transmitting and/or receiving and/or decoding a bitstream or signal that includes one or more of the described syntax elements, or variations thereof;
Creating and/or transmitting and/or receiving and/or decoding according to any of the embodiments described;
A method, process, apparatus, medium storing instructions, medium storing data, or signal according to any of the embodiments described;
A TV, set-top box, cell phone, tablet, or other electronic device that performs adaptation of the encoding or decoding process according to any of the embodiments described;
A TV, set-top box, cell phone, tablet, or other electronic device that performs adaptation of encoding or decoding process according to any of the embodiments described, and that displays (e.g. using a monitor, screen, or other type of display) a resulting image;
A TV, set-top box, cell phone, tablet, or other electronic device that selects (e.g. using a tuner) a channel to receive a signal including an encoded image, and performs adaptation of the decoding process according to any of the embodiments described;
A TV, set-top box, cell phone, tablet, or other electronic device that receives (e.g. using an antenna) a signal over the air that includes an encoded image, and performs adaptation of the decoding process according to any of the embodiments described.

1. A method for decoding comprising:
obtaining video data comprising a portion comprising high level syntax elements, at least one of said high level syntax elements providing an information indicating if a use of an encoding tool or feature corresponding to the at least one high level syntax element is allowed in the video data; and
determining from the at least one high level syntax element comprised in the portion if a use of an encoding tool or feature is allowed for decoding the video data, wherein the portion is representative of a general constraint information and the encoding tool or feature allows combining at least a binary tree and a ternary tree in a same hierarchical tree.

2. A method for encoding comprising:
obtaining a video sequence to encode in video data and a set of encoding constraints; and
setting a value of a high level syntax element in a portion of the video data comprising high level syntax elements in function of the data representative of the set of encoding constraints, at least one of said high level syntax elements providing an information indicating if a use of an encoding tool or feature corresponding to the at least one high level syntax element is allowed for encoding the video sequence, wherein the portion is representative of a general constraint information and the encoding tool or feature allows combining at least a binary tree and a ternary tree.

3. A device for decoding comprising:
means for obtaining video data comprising a portion comprising high level syntax elements, at least one of said high level syntax elements providing an information indicating if a use of an encoding tool or feature corresponding to the at least one high level syntax element is allowed in the video data; and
means for determining from the at least one high level syntax element comprised in the portion if a use of an encoding tool or feature is allowed for decoding the video data, wherein the portion is representative of a general constraint information and the encoding tool or feature allows combining at least a binary tree and a ternary tree in a same hierarchical tree.

4. A device for encoding comprising:
means for obtaining a video sequence to encode in video data and a set of encoding constraints; and
means for setting a value of a high level syntax element in a portion of the video data comprising high level syntax elements in function of the data representative of the set of encoding constraints, at least one of said high level syntax elements providing an information indicating if a use of an encoding tool or feature corresponding to the at least one high level syntax element is allowed for encoding the video sequence, wherein the portion is representative of a general constraint information and the encoding tool or feature allows combining at least a binary tree and a ternary tree.

5. (canceled)

6. A signal comprising data representative of a portion of video data comprising high level syntax elements, at least one of said high level syntax elements providing an information indicating if a use of an encoding tool or feature corresponding to the at least one high level syntax element is allowed in the video data; wherein the portion is representative of a general constraint information and the encoding tool or feature is at least one of Multi-Type Tree, a scaling matrix, Long Term Reference Picture, a maximum transform unit size equal to a predetermined highest possible maximum transform unit size or weighted prediction.

7. (canceled)

8. An information storage medium storing program code instructions for implementing the method according to claim 1.

9. An information storage medium storing program code instructions for implementing the method according to claim 2.
